(19) United States
(12) Patent Application Publication
(10) Pub. No.: US 2015/0147660 A1
(43) Pub. Date: May 28, 2015

(54) ALL SOLID SECONDARY BATTERY AND METHOD OF PREPARING ALL SOLID SECONDARY BATTERY

(71) Applicant: Samsung Electronics Co., Ltd., Suwon-si (KR)

(72) Inventors: Satoshi FUJIKI, Osaka (JP); Yuichi AIHARA, Osaka (JP); Hajime TSUCHIYA, Osaka (JP)

(21) Appl. No.: 14/551,657

(22) Filed: Nov. 24, 2014

(30) Foreign Application Priority Data
Nov. 26, 2013 (JP) 2013-244428
Oct. 30, 2014 (KR) 10-2014-0149332

(51) Int. Cl. H01M 10/0562; H01M 10/058

(52) U.S. Cl. CPC H01M 10/0562; H01M 10/058
USPC 429/306; 429/217; 29/623.5

(57) ABSTRACT

An all solid secondary battery including a positive electrode layer; a negative electrode layer; and a solid electrolyte layer disposed between the positive electrode layer and the negative electrode layer, wherein at least one of the positive electrode layer, the negative electrode layer, and the solid electrolyte layer includes a solid electrolyte including a first binder that is insoluble in a non-polar solvent and is non-continuously present in at least one of the positive electrode layer, the negative electrode layer, and the solid electrolyte layer, and a second binder that is soluble in non-polar solvent and is continuously present in at least one of the positive electrode layer, the negative electrode layer, and the solid electrolyte layer, wherein a solubility parameter of the first binder and a solubility parameter of the second binder are different from each other.

### RELATED APPLICATIONS

This application claims the benefit of and priority to Japanese Patent Application No. 2013-0244428, filed on Nov. 26, 2013, and Korean Patent Application No. 10-2014-0149332, filed on Oct. 30, 2014, in the Korean Intellectual Property Office, and all the benefits accruing therefrom under 35 U.S.C. §119, the content of which is incorporated herein in its entirety by reference.

### BACKGROUND

1. Field

The present disclosure relates to an all solid secondary battery, and a method of preparing the all solid secondary battery.

2. Description of the Related Art

All solid secondary batteries have a stack structure including a negative electrode layer, a solid electrolyte layer, and a positive electrode layer stacked in series. As a solid electrolyte included in each of the layers, a sulfide, which is highly ion conductive, may be used. Also, as a binder adhering particles of a positive electrode active material, a solid electrolyte, and a negative electrode active material in the stack structure, styrene butadiene rubber (SBR) or polyvinylidene fluoride (PVdF) may be used. There remains a need for an improved solid electrolyte and a battery including the solid electrolyte.

### SUMMARY

Provided is an all solid secondary battery having a long lifespan and which includes a positive electrode layer, a negative electrode layer, and a solid electrolyte layer that are strongly bound each other. In particular, the all solid secondary battery includes a sulfide solid electrolyte and has high adhesive properties and high ion conductivity.

Additional aspects will be set forth in part in the description which follows and, in part, will be apparent from the description.

According to an aspect, an all solid secondary battery includes a positive electrode layer; a negative electrode layer; and a solid electrolyte layer that is disposed between the positive electrode layer and the negative electrode layer, a first binder that is insoluble in a non-polar solvent and is non-continuously present in at least one of the positive electrode layer, the negative electrode layer, and the solid electrolyte layer, and a second binder that is soluble in non-polar solvent and is continuously present in at least one of the positive electrode layer, the negative electrode layer, and the solid electrolyte layer, and wherein a solubility parameter of the first binder and a solubility parameter of the second binder are different than each other.

The solid electrolyte included in at least one of the positive electrode layer, the negative electrode layer, and the solid electrolyte layer may be inert with respect to the non-polar solvent.

The solid electrolyte included in at least one of the positive electrode layer, the negative electrode layer, and the solid electrolyte layer may be a sulfide-based solid electrolyte.

The sulfide-based solid electrolyte may include Li₂S—P₂S₅.

The solubility parameter (SP) of the first binder may be in a range of about 20 MPa^{1/2} or greater to about 30 MPa^{1/2} or less.

An absolute value of a difference between the SP of the first binder and the non-polar solvent may be about 5 or greater.

The SP of the second binder may be in a range of about 5 MPa^{1/2} or greater to less than about 20 MPa^{1/2}.

An absolute value of a difference between the SP of the second binder and a SP of the non-polar solvent may be less than about 15.

A particle diameter of the first binder may be in a range of about 0.01 micrometer (μm) to about 10 μm.

The first binder may be a compound including a structural unit represented by Formula 1:

—(CH₂—CF₂)—. Formula 1

An absolute value of a difference between the SP of the first binder and the SP of the second binder may be about 3 or greater.

The first binder may be compound including a structural unit represented by Formula 2:

—(CH₂—CH(OH))— Formula 2

An absolute value of a difference between the SP of the first binder and the SP of the second binder may be about 1 or greater.

The first binder may include at least one selected from polyvinylidene fluoride (PVdF), polyvinyl alcohol (PVA), a polyacrylic acid ester copolymer, a vinyl idenefluoride-hexafluoropropylene (VDF-HFP) copolymer, polychloroethylene, polymethacrylic acid ester, an ethylene-vinyl alcohol copolymer, polyimide, polyamide, polyamideimde, and a partially or completely hydrogenated product or a carbonic acid-modified product of the polymers.

The second binder may be a hydrocarbon-based polymer.

The second binder may include at least one selected from styrene butadiene rubber (SBR), butadiene rubber (BR), nitrile butadiene rubber (NBR), a styrene butadiene styrene block copolymer (SBS), a styrene ethylene butadiene block copolymer (SEB), and a styrene-(styrene butadiene)-styrene block copolymer; natural rubber (NR); isoprene rubber (IR); and an ethylene-propylene-diene ternary copolymer (EPDM).

The first binder and the second binder may have a sea-island structure, in which the second binder is a sea component and the first binder is an island component.

The sea-island structure may be formed around at least one of an active material particle or a solid electrolyte particle.

The non-polar solvent may be at least one selected from toluene, xylene, benzene, pentane, hexane, and heptane.

According to an aspect, a method of preparing an all solid secondary battery includes at least one of: adding a positive electrode active material, a solid electrolyte, a first binder that is insoluble in a non-polar solvent, and a second binder that is soluble in the non-polar solvent into the non-polar solvent to prepare a positive electrode mixture; adding a negative electrode active material, a solid electrolyte, a first binder that is insoluble in the non-polar solvent, and a second binder that is soluble in the non-polar solvent into the non-polar solvent to prepare a negative electrode mixture; mixing a solid electrolyte, a first binder that is insoluble in the non-polar solvent, and a second binder that is soluble in the non-polar solvent to prepare a solid electrolyte layer; and disposing the solid electrolyte layer between a positive electrode layer and a negative electrode layer to prepare an all solid secondary battery.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic view of an embodiment of an all solid secondary battery; and

FIG. 2 is a schematic view of an embodiment of a positive electrode layer including a first binder and a second binder.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure.

Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Japanese patent publication 2009-289534, and Japanese patent publication 2010-262764, the contents of which are incorporated herein by reference in their entirety, provide examples using SBR as a binder in a solid battery. In regard of an all solid lithium secondary battery disclosed in Japanese patent publication 2010-262764, a resin layer containing SBR is disposed between a metal layer, which is a current collector, and each of electrode layers. However, an adhesive strength of SBR is weak. Thus, an interlayer detachment may be prevented by increasing adherence by roughening a surface of the metal layer facing the resin layer. Japanese patent publication 2010-262764 discloses a slurry for forming a positive electrode composite layer containing a positive electrode active material, a solid electrolyte material, SBR, and a conducting agent. Adhesion between particles of the slurry is insufficient. As disclosed in Japanese patent publication 2009-289534, and Japanese patent publication 2010-262764, when SBR is used as a binder of an all solid secondary battery, a structure for improving adhesion within a stack structure is needed. The additional structure increased a complexity of a device and increases manufacturing cost.

PVdF has a high adhesive strength but is insoluble in non-polar solvent. Thus, as a solvent of a slurry including PVdF, a polar solvent such as N-methylpyrrolidone (NMP) may be used. However, in preparation of a slurry of a positive electrode mixture or a negative electrode mixture for a solid secondary battery, when a sulfide solid electrolyte in a polar solvent is added, an alkali component derived from the sulfide solid electrolyte reacts with the polar solvent, and thus the solution may not maintain a slurry state. Such solution deteriorates handling properties and degrades production efficiency of the all solid secondary battery.

Further, in a preparation process of a layer containing the sulfide solid electrolyte, a polar solvent is removed by drying a mixture coated on a substrate. However, when an electrode layer or a solid electrolyte layer is formed using the mixture, a high ion conductivity, which is expected by the inclusion of the sulfide solid electrolyte, may not be obtained. As one of reasons causing this, it is presumed that the polar solvent within the composite and the sulfide solid electrolyte reacts during the drying period, and thus a lithium ion conductivity of the sulfide solid electrolyte in the electrode layer may deteriorate.

Therefore, a non-polar solvent may be used as a solvent of the slurry including a sulfide solid electrolyte. In this case, PVdF is not dissolved in the non-polar solvent and thus may not be homogenously dispersed within the slurry. Therefore, PVdF may not exhibit homogenous adhesion within a structure of the all solid secondary battery and may cause interlayer detachment. Japanese patent publication 2013-125507, the content of which is incorporated herein by reference in its entirety, discloses a solid secondary battery having two types of binders such as a styrene-based thermoplastic elastomer and an acid-modified PVdF and a binding layer formed by using a slurry having NMP as a solvent disposed between a positive electrode layer and a current collector member. In the solid secondary battery, since the binding layer is included, the number of manufacturing steps increases, and thus a manufacturing cost increases.

In this regard, an all solid secondary battery with each of components that are strongly and firmly adhered to have a long lifespan is desired, and the all solid secondary battery is desirably manufactured at a low cost. Further, it would be desirable to provide a high ion conductivity in the battery, which may be prepared using a sulfide solid electrolyte.

“Alkali metal” means a metal of Group 1 of the Periodic Table of the Elements, i.e., lithium, sodium, potassium, rubidium, cesium, and francium.

“Alkaline-earth metal” means a metal of Group 2 of the Periodic Table of the Elements, i.e., beryllium, magnesium, calcium, strontium, barium, and radium.

“Transition metal” as defined herein refers to an element of Groups 3 to 11 of the Periodic Table of the Elements.

“Rare earth” means the fifteen lanthanide elements, i.e., atomic numbers 57 to 71, plus scandium and yttrium.

The “lanthanide elements” means the chemical elements with atomic numbers 57 to 71.

Hereinafter, an all solid secondary battery and a method of preparing the same will be disclosed in further detail.

### All Solid Secondary Battery

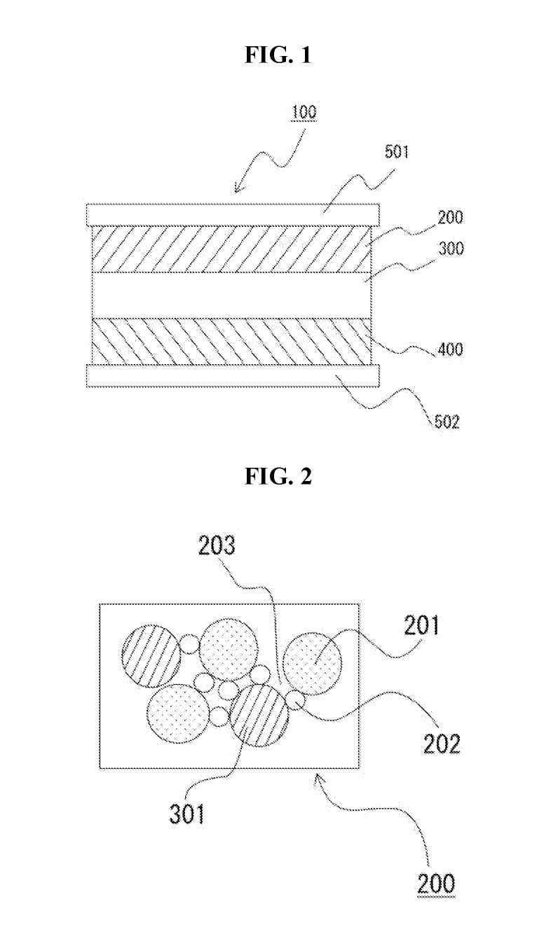

According to an embodiment, an all solid secondary battery has a stack structure including a positive electrode layer, a solid electrode layer, and a negative electrode layer that are stacked. FIG. 1 is a schematic view of an example of the all solid secondary battery. In FIG. 1, 100 is an all solid secondary battery, 200 is a positive electrode layer, 300 is a solid electrolyte layer, 400 is a negative electrode layer, and 501 and 502 are a positive and negative current collector, respectively.

The positive electrode layer 200 includes particles of a positive electrode active material and optionally a solid electrolyte. The solid electrolyte layer 300 includes particles of a solid electrolyte. The negative electrode layer 400 includes a negative electrode active material and optionally a solid electrolyte. Since the particles of a solid electrolyte are included in the positive electrode layer 200 and/or the negative electrode layer 400, an interface between the particles of a solid electrolyte and the particles of a positive electrode active material or the particles of a negative electrode active material may be improved, and an ion conductivity of the positive electrode layer 200 and the negative electrode layer 400 may increase.

The positive electrode layer 200, the solid electrolyte layer 300, and the negative electrode layer 400 contains a binder. In the all solid secondary battery, the binder comprises a first binder and a second binder. The second binder is present continuously in each of the layers and thus contacts and binds with the particles of an active material or a solid electrolyte contained in each of the layers. Thus, an interface between the positive electrode layer 200 and the solid electrolyte layer 300 or an interface between the negative electrode layer 400 and the solid electrolyte layer 300 may provide improved adhesion.

Further, in the all solid secondary battery, at least one of the positive electrode layer 200, the solid electrolyte layer 300, and the negative electrode layer 400 additionally contains a first binder. The first binder is non-continuously present in a layer containing the first binder. The first binder has a binding strength, i.e., adhesion, that is stronger than that of the second binder. In a preparation process of the all solid secondary battery, the stack structure may be integrated by applying a pressure thereon. In the stack structure of the all solid secondary battery, a layer containing the first binder and the second binder already retains adhesion between particles, such as the active material particles, the solid electrolyte particles and the like, due to the second binder before the pressing.

Further, particles of the first binder are interposed between the adhered particles. The particles of the first binder are understood to fuse when the stack structure is pressed and thus may exhibit strong adhesive strength in a region interposed between the particles. In this regard, the active material particles or the solid electrolyte may be strongly and firmly adhered. Accordingly, although the first binder is non-continuously, i.e., non-homogeneously, present in the layer, the adhesive strength due to the first binder may contribute to preventing detachment between layers of the stack structure in the all solid secondary battery. Therefore, the all solid secondary battery may have a low possibility of interlayer detachment even after repeated charging and discharging, and may have a long lifespan.

In the all solid secondary battery, even when a layer including the first binder and the second binder is only one of the positive electrode layer, the negative electrode layer, or the solid electrolyte layer, the all solid secondary battery may have the effect described above. When both of the first and second binders are contained in each of the adhered layers, the adhesive property may be further increased. In the case when both of the first and second binders are contained in all of the layers, the all solid secondary battery may have the stack structure that is more strongly and firmly adhered.

### Positive Electrode Layer

Hereinafter, an embodiment in which the positive electrode layer of the all solid secondary battery contains a first binder and a second binder is further disclosed. FIG. 2 is a schematic view of an example of the positive electrode layer of the all solid secondary battery. In FIG. 2, 200 is a positive electrode layer, 201 is a positive electrode active material, 202 is a first binder, 203 is a second binder, and 301 is a solid electrolyte. The positive electrode layer 200 shown in FIG. 2 may comprise the second binder 203, which is continuously present, and the first binder 202 which is non-continuously present, in the layer. In other words, the positive electrode layer 200 may have a sea-island structure which includes the first binder 202 of particulate as an island component and the second binder 203 as a sea component around the positive electrode active material 201 or the solid electrolyte 301. Further, the positive electrode layer 200 may include a conducting agent that is not shown in FIG. 2.

A first binder included in the all solid secondary battery may have an adhesive property that is stronger than that of a second binder, which will be described later in the specification. The strength of the adhesive property may be evaluated by measuring a strength needed to peel off a binder sheet, which is obtained by coating and drying a binder solution on a support, from the support using a commercially available peel tester.

The first binder may be a compound comprising a structural unit represented by Formula 1. Examples of the compound may include polyvinylidene fluoride (PVdF). The first binder may be a compound comprising a structural unit represented by Formula 2, and may comprise at least one selected from a polyvinyl alcohol (PVA), a polyacrylic acid ester copolymer, a vinylidenefluoride-hexafluoropropylene (VDF-HFP) copolymer, polychloroethylene, polymethacrylic acid ester, an ethylene-vinyl alcohol copolymer, polyimide, polyamide, polyamideimde, and a hydrogenated or a carbonic acid-modified derivative thereof, e.g., a partially hydrogenated product of the polymers, a completely hydrogenated product of the polymers, or a carbonic acid-modified product of the polymer.

A molecular weight of the compound may be in a range of about 1×10⁵ to about 1×10⁷, for example, in a range of about 2×10⁵ to about 8×10⁶ Daltons (Da). When a molecular weight of the compound is less than about 1×10⁵ Da, an adhesive strength may be insufficient. When a molecular weight of the compound exceeds 1×10⁷ Da, a viscosity of a slurry including the compound may be too high, thus coating of the slurry may not be easy.

The first binder may be sufficiently fused in the positive electrode layer by the pressure applied to the positive electrode layer while forming the positive electrode layer or while integrating the stack structure of the all solid secondary battery. Thus, when the first binder is interposed between the particles of the positive electrode active material or the solid electrolyte, a contacting area between the particles of the positive electrode active material or the solid electrolyte and the first binder may increase after the pressing process. In this regard, adhesive property between the particles may improve. That is, in the all solid secondary battery, since the first binder having a strong adhesive strength is insoluble in a solvent of a positive electrode mixture, the first binder is present in the positive electrode mixture as a particulate or a bulk. Therefore, even in the case that the first binder is present non-continuously within the positive electrode layer, adhesion between the particles such as the positive electrode active material, the solid electrolyte and the like may be improved.

In view of sufficient fusing of the first binder through the pressing process, an average particle diameter of the first binder may be in a range of about 0.01 micrometers (μm) to about 10 μm, for example, about 0.1 μm to about 5 μm. When an average particle diameter is greater than 10 μm, the first binder is not sufficiently fused and thus may not sufficiently produce a binding effect as a first binder. The average particle diameter is measured by measuring particle diameters of randomly selected 50 particles using a dry particle size distribution measuring apparatus, and then an average value of the particle diameters calculated therefrom is used as an average particle diameter.

The second binder included in the all solid secondary battery is soluble in a solvent of a positive electrode mixture and may be homogenously dispersed in the positive electrode mixture. When the all solid secondary battery includes the second binder, a second binder may be continuously present in the positive electrode layer. In this regard, since an adhered state of the positive electrode active material or the solid electrolyte may be maintained, and along with the action of the first binder, the stack structure of the battery may be improved.

The second binder may be a hydrocarbon-based polymer. A molecular weight of the hydrocarbon-based polymer may be in a range of about 100 to about 100,000 Da, for example, about 1000 to about 10,000 Da. When a molecular weight of the hydrocarbon-based polymer is less than 100 Da, the second binder may not obtain sufficient binding strength. When a molecular weight of the hydrocarbon-based polymer is greater than 100,000 Da, a viscosity of a slurry may be too high, thus coating the slurry may not be easy. The second binder may include styrene-based thermoplastic elastomer and may comprises at least one selected from a styrene butadiene rubber (SBR), butadiene rubber (BR), nitrile butadiene rubber (NBR), a styrene butadiene styrene block copolymer (SBS), a styrene ethylene butadiene styrene block copolymer (SEB), and a styrene-(styrene butadiene)-styrene block copolymer, natural rubber (NR), isoprene rubber (IR), and an ethylene-propylene-diene ternary copolymer (EPDM).

As shown in FIG. 2, in order to form the positive electrode layer containing the non-continuously present first binder and the continuously present second binder in the layer, two types of binders having different solubility parameter (SP) values are used as the first binder and the second binder. The solubility parameter (SP) is calculated using the Hoy method.

An absolute value of difference between a SP value of the first binder having a structural unit represented by Formula 1 and a SP value of the second binder may be 3 or greater. An absolute value of difference between a SP value of the first binder having a structural unit represented by Formula 2 and a SP value of the second binder may be 1 or greater. Such different ranges of the absolute values of the differences of the SP values of the second binders and the SP values of the first binders according to the type of the first binders may be caused by different distribution of the SP values obtained when the first binder having a structural unit represented by Formula 1 and the first binder having a structural unit represented by Formula 2 are added into the same non-polar solvent.

When the first binder having a structural unit represented by Formula 1 or Formula 2 is used, in either case, if the absolute value of the difference between the SP value of the first binder and the SP value of the second binder is less than the least value of the above-mentioned range, the first binder and the second binder become dissolved in the same solvent, thus the structure such as disclosed in FIG. 2 may not be formed.

As the absolute value of the difference between the SP values increases, a structure of the all solid secondary battery including the second binder that is continuously present and the first binder that is non-continuously present may be easily formed. Thus, there is no upper limit to the difference between the SP values of the first and second binders. However, considering types of the first binder and the second binder that may be selected in terms of availability or ease of handling of each of the binders, an absolute value of the difference between the SP values of the first binder having a structural unit represented by Formula 1 and the second binder may be in a range of 3 or greater to 25 or less. Further, an absolute value of the difference between the SP values of the first binder having a structural unit represented by Formula 2 and the second binder may be in a range of 1 or greater to 25 or less.

A method of forming the positive electrode layer of the all solid battery is not limited, but a method of preparing a positive electrode layer by coating a positive electrode mixture of a slurry state on a current collector and drying the slurry to remove the solvent may be used. The positive electrode mixture is prepared by mixing a positive electrode active material, a solid electrolyte, a first binder, and a second binder in a solvent. The first binder and the second binder have different SP values within the above-mentioned ranges. When the difference in the SP values of the first binder and the second binder is expressed relative to a SP value of the solvent, an absolute value of the difference between the SP value of the first binder and the SP value of the solvent is larger than an absolute value of the difference between the SP value of the second binder and the SP value of the solvent. That is, compared to the second binder, dissolving the first binder in the solvent may be difficult, and the first binder may not be dissolved in the solvent at all or may remain undissolved. Also, the second binder is dissolved in the solvent. When the positive electrode layer is formed using a slurry of the positive electrode mixture, the first binder may be non-continuously present in the positive electrode layer, and the second binder may be continuously present in the positive electrode layer.

The solvent used to prepare the positive electrode mixture may be a non-polar solvent, such as toluene or xylene, in terms of maintaining a slurry state of the positive electrode mixture. A SP value of the non-polar solvent is in a range of about 5 megapascals^{1/2} (MPa^{1/2}) to about 19 MPa^{1/2}. Thus, a SP value of the first binder may be 20 MPa^{1/2} or greater, or, for example, about 21 MPa^{1/2} or greater. Although a SP value of the first binder does not have an upper limit, when a difference between the SP values of the first binder and the second binder is too large, phase separation may occur, and thus homogeneous dispersion of the particles in the slurry may be difficult. Therefore, a SP value of the first binder may be 30 MPa^{1/2} or lower.

An absolute value of the difference between a SP value of the second binder and a SP value of a non-polar solvent used to prepare the second binder may be in a range of about greater than 0 to about 15, or less, or, for example, about greater than 0 to about 10, or less. When an absolute value of the difference of the SP values exceeds 15, the second binder may not be dissolved in the non-polar solvent. When an absolute value of the difference of the SP values is close to 0, the second binder may be easily dissolved in the non-polar solvent. The second binder may have a SP value in a range of about 5 MPa^{1/2} or greater to about 20 MPa^{1/2}, or less, for example, about 10 MPa^{1/2}] or greater to about 19.5 MPa^{1/2}, or, for example, about 10 MPa^{1/2} or greater to about 19 MPa^{1/2}. The first binder and the second binder used in preparation of the all solid secondary battery may each have a difference between the SP values thereof and the SP value of the solvent of the slurry that are different from each other. Further, the first binder and the second binder may be each selected to have a SP value according to the respective ranges described above.

The positive electrode layer of the all solid secondary battery may include a solid electrolyte and a positive electrode active material besides the first binder and the second binder. Further, the positive electrode layer may additionally include a conducting agent. The solid electrolyte included in the positive electrode layer may be any suitable solid electrolyte available in the art. In particular, examples of the solid electrolyte may include at least one selected from Li₃N, LISICON, lithium phosphate oxynitride (LiPON), thio-LiSICON (Li_{3.25}Ge_{0.25}P_{0.75}S₄), and Li₂O—Al₂O₃—TiO₂—P₂O₅ (LATP). Further, examples of the solid electrolyte having high ion conductivity may include at least one selected from Li₃PS₄, Li₇P₃S₁₁, Li₆PS₅Cl, and Li₃PO₄.

An ion conductivity Li₃PS₄ of may be in a range of about 10⁻⁴ Siemens per centimeter (S/cm) to about 10⁻³ S/cm. An ion conductivity of Li₇P₃S₁₁ may be in a range of about 10⁻³ S/cm to about 10⁻² S/cm. An ion conductivity of Li₆PS₅Cl may be in a range of about 10⁻⁴ S/cm to about 10⁻³ S/cm. An ion conductivity of Li₃PS₄ may be in a range of about 10⁻⁵ S/cm to about 10⁻⁴ S/cm.

The positive electrode active material included in the positive electrode layer of the all solid secondary battery may be any suitable positive electrode active material capable of reversely intercalating/deintercalating lithium ions. Examples of the positive electrode active material may include at least one selected from lithium cobalt oxide (LCO), lithium nickel oxide, lithium nickelcobalt oxide, lithium nickel cobalt aluminum oxide (NCA), lithium nickel cobalt manganese oxide (NCM), lithium manganese oxide, lithium nickel manganese oxide, and lithium iron phosphate. Among the examples of the positive electrode active material, a lithium transition metal oxide having a structure of a layered rock salt type may be used.

For example, the positive electrode active material may be at least one composite oxide of a metal and lithium, where the metal is at least one selected from cobalt, manganese, and nickel, and examples of the composite oxide may include a compound represented by at least one selected from the formulas: LiₐA_{1-b}M_{b}R₂ (where, 0.90≦a≦1 and 0≦b≦0.5); LiₐE_{1-b}M_{b}O_{2-c}R_{c} (where, 0.90≦a≦1, 0≦b≦0.5, and 0≦c≦0.05); LiE_{2-b}M_{b}O_{4-c}R_{c} (where, 0≦b≦0.5 and 0≦c≦0.05); LiₐNi_{1-b-c}Co_{b}M_{c}R_{α} (where, 0.90≦a≦1, 0≦b≦0.5, 0≦c≦0.05, and 0<α≦2); LiₐNi_{1-b-c}Co_{b}M_{c}O_{2-α}X_{α} (where, 0.90≦a≦1, 0≦b≦0.5, 0≦c≦0.05, and 0<α<2); LiₐNi_{1-b-c}Co_{b}M_{c}O₂₋ₐX₂ (where, 0.90≦a≦1, 0≦b≦0.5, 0≦c≦0.05, and 0<a<2); LiₐNi_{1-b-c}Mn_{b}M_{c}Rₐ (where, 0.90≦a≦1, 0≦b≦0.5, 0≦c≦0.05, and 0<α<2); LiₐNi_{1-b-c}Mn_{b}M_{c}O_{2-α}X_{α} (where, 0.90≦a≦1, 0≦b≦0.5, 0≦c≦0.05, and 0<a<2); LiₐNi_{1-b-c}Mn_{b}M_{c}O_{2-α}X₂ (where, 0.90≦a≦1, 0≦b≦0.5, c≦0.05, and 0<a<2); LiₐNi_{b}E_{c}G_{d}O₂ (where, 0.90≦a≦1, 0≦b≦0.9, 0≦c≦0.5, and 0.001≦d≦0.1); LiₐNi_{b}Co_{c}Mn_{d}GeO₂ (where, 0.90≦a≦1, 0≦b≦0.9, 0≦c≦0.5, 0≦d≦0.5, and 0.001≦e≦0.1); LiₐNiG_{b}O₂ (where, 0.90≦a≦1 and 0.001≦b≦0.1); LiₐCoG_{b}O₂ (where, 0.90≦a≦1 and 0.001≦b≦0.1); LiₐMnG_{b}O₂ (where, 0.90≦a≦1 and 0.001≦b≦0.1); LiₐMn₂G_{b}O₄ (where, 0.90≦a≦1 and 0.001≦b≦0.1); QO₂; QS₂; LiQS₂; V₂O₅; LiV₂O₅; LiM′O₂; LiNiVO₄; Li_{(3-f)}J₂(PO₄)₃ (where, 0≦f≦2); Li_{(3-f)}Fe₂(PO₄)₃ (where, 0≦f≦2); and LiFePO₄.

In the formulas, A is at least one selected from Ni, Co, and Mn; M is at least one selected from Al, Ni, Co, Mn, Cr, Fe, Mg, Sr, V, and a rare earth element; R is at least one selected from O, F, S, and P; E is at least one selected from Co and Mn; X is at least one selected from F, S, and P; G is at least one selected from Al, Cr, Mn, Fe, Mg, La, Ce, Sr, and V; Q is at least one selected from Ti, Mo, and Mn; M′ is Cr, V, Fe, Sc, and Y; and J is at least one selected from V, Cr, Mn, Co, Ni, and Cu.

For example, the positive electrode active material may be at least one selected from LiCoO₂, LiMnₓO₂ₓ (where, x=1, 2), LiNi₁₋ₓMnₓO₂ₓ (where, 0<x<1), LiNi_{1-x-y}CoₓMn_{y}O₂ (where, 0≦x≦0.5 and 0≦y≦0.5), and FePO₄.

In some embodiments, a compound represented by any one of the formulas and having a coating layer may be used alone, or a compound represented by any one of the formulas and the compound having a coating layer may be used as a mixture. The coating layer may include a coating element compound in a form of an oxide, hydroxide, oxyhydroxide, oxycarbonate, or hydroxycarbonate of a coating element. The compound forming the coating layer may be amorphous or crystalline. The coating element included in the coating layer may be at least one selected from Mg, Al, Co, K, Na, Ca, Si, Ti, V, Sn, Ge, Ga, B, As, and Zr. Any suitable coating method may be used for a process of forming a coating layer as long as coating may be performed using a method (e.g., spray coating or dipping) that does not adversely affect the physical properties of the cathode active material due to using such elements for the compound.

In terms of contents of compositions with respect to 100 parts by weight of the positive electrode layer, an amount of the positive electrode active material may be in a range of about 40 parts to about 99 parts by weight, or, for example, about 50 parts to about 95 parts by weight. An amount of the solid electrolyte may be in a range of about 1 part to about 50 parts by weight, or, for example, about 1 part to about 45 parts by weight, for example, about 5 parts to about 40 parts by weight. An amount of the first binder may be in a range of about 0.05 part to about 10 parts by weight, or, for example, about 0.4 part to about 9 parts by weight, for example, about 0.5 part to about 8 parts by weight, for example, about 0.5 part to about 6 parts by weight. An amount of the second binder may be in a range of about 0.05 part to about 5 parts by weight, or, for example, about 0.2 part to about 3 parts by weight. When the contents of the each components are included in the positive electrode layer within these ranges above, the positive electrode layer may have excellent ion conductivity, and adhesive properties of the particles of each of the compositions may be improved.

The positive electrode layer may further include a conducting agent. Examples of the conducting agent may include at least one selected from graphite, carbon black, acetylene black, Ketjen black, carbon fibers, and a metal powder, and the like.

### Negative Electrode Layer

A negative electrode layer of the all solid secondary battery may include at least a negative electrode active material and a solid electrolyte and may include either or both of a first binder and a second binder. Further, the negative electrode layer may additionally include a conducting agent. When the negative electrode layer includes the first binder and the second binder, the first binder is non-continuously present in the negative electrode layer, and the second binder is continuously present in the negative electrode layer. A negative electrode active material used in preparation of the negative electrode layer may be any suitable material capable of intercalating or deintercalating metal ions such as a pure metal, an alloy, or a conductive material containing a metal. Examples of the negative electrode active material may include at least one selected from a lithium metal, a metal, such as lithium, indium, tin, aluminum, silicon, an alloy thereof, and a transition metal oxide, such as Li_{4/3}Ti_{5/3}O₄ or SnO. A carbonaceous material in which lithium ions are pre-doped may be used. As the carbonaceous material, for example, graphite, which may form an interlayer compound with lithium ions, may be used. The negative electrode active material may be used alone or as a mixture.

In particular, examples of the metal may include at least one selected from Sn, Al, Ge, Pb, Bi, Sb, a Si—Y′ alloy (where, Y′ is at least one selected from an alkali metal, an alkaline earth metal, a Group 13 element, a Group 14 element, a transition metal, and a rare earth element, except for Si), and a Sn—Y″ alloy (where, Y″ is at least one selected from an alkali metal, an alkaline earth metal, a Group 13 element, a Group 14 element, a transition metal, and a rare earth element except for Sn). Y″ may be at least one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, and Po.

For example, examples of the transition metal oxide may include a lithium titanium oxide, a vanadium oxide, and a lithium vanadium oxide.

For example, examples of a non-transition metal oxide may include SnO₂ and SiOₓ (where, 0<x<2).

For example, the carbon-based material may be crystalline carbon, amorphous carbon, or a mixture thereof. Examples of the crystalline carbon may include graphite such as spherical, sheet-shaped, flake, spherical, or fiber-shaped natural graphite or artificial graphite, and examples of the amorphous carbon may include soft carbon (carbon fired at a low temperature) or hard carbon, a mesophase pitch carbonized product, and fired coke.

The solid electrolyte, the first binder, and the second binder included in the negative electrode layer may be the same with those contained in the positive electrode layer. In terms of contents of compositions with respect to 100 parts by weight of the negative electrode layer, an amount of the negative electrode active material may be in a range of about 40 parts to about 99 parts by weight, or, for example, about 50 parts to about 95 parts by weight. An amount of the solid electrolyte may be in a range of about 1 part to about 50 parts by weight, or, for example, about 1 part to about 45 parts by weight, for example, about 5 parts to about 40 parts by weight. An amount of the first binder may be in a range of about 0.05 part to about 15 parts by weight, or, for example, about 0.1 part to about 10 parts by weight, for example, about 0.5 part to about 8 parts by weight. An amount of the second binder may be in a range of about 0.05 part to about 5 parts by weight, or, for example, about 0.1 part to about 5 parts by weight, for example, about 0.2 part to about 3 parts by weight. When the contents of the each components are included in the negative electrode layer within these ranges above, the negative electrode layer may have excellent ion conductivity, and adhesive property of the particles of each of the compositions may improve.

Solid Electrolyte Layer

The solid electrolyte of the all solid secondary battery includes either or both of a first binder and a second binder, and a solid electrolyte. When the solid electrolyte includes the first binder and the second binder, the first binder is non-continuously present in the solid electrolyte layer, and the second binder is continuously present in the solid electrolyte layer. The solid electrolyte may be commercially sourced, and an example of the solid electrolyte may be a sulfide solid electrolyte having excellent ion conductivity. In particular, examples of the solid electrolyte may include Li₃N, Li₂₊₂ₓZn₁₋ₓGeO₄ wherein 0<x<1 (LISICON), lithium phosphate oxynitride (LiPON), Li_{3.25}Ge_{0.25}P_{0.75}S₄ (thio-LiSICON), and Li₂O—Al₂O₃—TiO₂—P₂O₅ (LATP). Also, examples of the solid electrolyte having high ion conductivity may include Li₃PS₄, Li₇P₃S₁₁, and Li₆PS₅Cl. Although a higher ion conductivity of the sulfide solid electrolyte included in the all solid secondary battery may be preferable, the ion conductivity of the sulfide solid electrolyte may be in a range of about 10⁻⁴ Siemens per centimeter (S/cm) to about 10⁻² S/cm. When an ion conductivity is lower than about 10⁻⁴ S/cm, a charging/discharging capacity may significantly decrease. An ion conductivity of Li₃PS₄ may be in a range of about 10⁻⁴ S/cm to about 10⁻³ S/cm. An ion conductivity of Li₇P₃S₁₁ may be in a range of about 10⁻³ S/cm to about 10⁻² S/cm. An ion conductivity of Li₆PS₅Cl may be in a range of about 10⁻⁴ S/cm to about 10⁻³ S/cm.

The sulfide solid electrolyte may be prepared by mixing Li₂S and P₂S₅ at a mixing ratio in a range of about 50:50 to about 80:20. When a mixing ratio exceeds this range, the sulfide solid electrolyte obtained therefrom may not have a desired ion conductivity. As additional components, the sulfide solid electrolyte may include SiS₂, GeS₂, or B₂S₃ to further improve its ion conductivity. The sulfide solid electrolyte may be amorphous or crystalline. For example, the sulfide solid electrolyte may be amorphous since an amorphous electrolyte has good contacting property with an active material.

The sulfide solid electrolyte may be prepared by using a mixing method, such as a mechanical milling method (a MM method) or a solution method. The MM method refers to a method of mixing starting materials by adding the starting materials and a ball mill in a reactor and intensely stirring the content to finely pulverize the starting materials. The solution method refers to a method of preparing a solid electrolyte as a precipitate by mixing starting materials in a solvent.

Method of Preparing all Solid Secondary Battery

According to another embodiment, a method of preparing an all solid secondary battery is not particularly limited as long as the effect of the all solid secondary battery can be obtained by using the method. Examples of the preparation method may include a method as follows. That is, first, a current collector is coated with a positive electrode mixture or a negative electrode mixture and dried to prepare a positive electrode layer and a negative electrode layer, then a solid electrolyte layer is interposed between the positive electrode layer and the negative electrode layer to form a stack structure, and the stack structure is press-molded to be integrated.

The preparation method includes at least one step of preparing a positive electrode mixture, a process of preparing a negative electrode mixture, and a process of forming a solid electrolyte layer, so that a first binder may be non-continuously present and the second binder may be continuously present in each of the layers.

Process of Preparing Positive Electrode Mixture

A positive electrode mixture used in the preparation method may be prepared by adding a positive electrode active material, a solid electrolyte, a first binder insoluble in non-polar solvent, and a second binder soluble in non-polar solvent into a non-polar solvent, and mixing the mixture. The solid electrolyte included in the positive electrode mixture may be any typical solid electrolyte used in an all solid secondary battery, and, for example, the sulfide solid electrolyte having high ion conductivity as described above may be used as the solid electrolyte. The positive electrode active material may be a typical positive electrode active material described above.

In the preparation method, a solvent of the positive electrode mixture for the all solid secondary battery may be a polar solvent or a non-polar solvent. For example, the solvent of the positive electrode mixture may be a non-polar solvent. When the non-polar solvent is used, handling property of the positive electrode mixture may be well maintained even when the sulfide solid electrolyte is added to the positive electrode mixture. Further, possible problems that may arise, by adding the sulfide solid electrolyte to a polar solvent, in the prepared positive electrode mixture may be prevented. That is, when a positive electrode mixture includes a polar solvent, the polar solvent and the sulfide solid electrolyte may react during a positive electrode formation process including coating and drying steps using the positive electrode mixture, and thus a lithium ion conductivity of the sulfide solid electrolyte may be deteriorated. In contrast, when the non-polar solvent is used, a reaction between the polar solvent and the sulfide solid electrolyte does not occur, and thus the sulfide solid electrolyte added to the positive electrode mixture may be contained in the positive electrode layer as it is, and thus deterioration of the ion conductivity of the all solid secondary battery may be prevented. Examples of the non-polar solvent may include aromatic hydrocarbon such as at least one selected from toluene, xylene, and ethylbenzene; and aliphatic hydrocarbon such as pentane, hexane, and heptane.

The second binder may be a binder that is non-polar solvent soluble. As used herein, the term “non-polar solvent soluble” denotes that a binder may be completely dissolved in a non-polar solvent and may be homogenously dispersed in the solvent. An absolute value of difference between a SP value of the non-polar solvent, selected as a solvent, and a SP value of the second binder may be in a range of about 0 or greater to less than about 15, or, for example, about 0 or greater to less than about 10, for example, about 0 or greater to less than about 5. Since the binder can be homogeneously dispersed within the solvent, the binder may easily adhere to a positive electrode active material or a solid electrolyte in any region of the positive electrode layer.

In order to efficiently dissolve the binder in the non-polar solvent, an absolute value of difference between a SP value of the non-polar solvent and a SP value of the second binder may be in a range of about 0 or greater to less than about 5. However, when an absolute value of difference between a SP value of the non-polar solvent and a SP value of the second binder may be in a range of about 0 or greater to less than about 15, the second binder may be dissolved in the non-polar solvent by appropriately controlling a temperature condition. Examples of the second binder may include at least one selected from a styrene-based thermoplastic elastomers such as SBR, butadiene rubber (BR), nitrile butadiene rubber (NBR), a styrene butadiene styrene block copolymer (SBS), a styrene ethylene butadiene styrene block copolymer (SEB), and a styrene-(styrene butadiene)-styrene block copolymer.

The first binder may be a binder that is insoluble in non-polar solvent. As used herein, the term “non-polar solvent insoluble” denotes that a binder is not dissolved in a non-polar solvent or remains in a melted or fused state without being completely dissolved. An absolute value of difference between a SP value of the non-polar solvent, selected as a solvent, and a SP value of the first binder may be about 5 or greater, or, for example, about 10 or greater. As an absolute value of difference between the SP values increases, the first binder may not be dissolved in the non-polar solvent and may be present as dispersed particles in a slurry of the positive electrode mixture. In terms of being present of the first binder in the positive electrode mixture as particles with a small diameter by dissolving the first binder as much as possible in the mixture, an absolute value of difference between a SP value of the non-polar solvent and a SP value of the first binder used in the preparation method may be in a range of about 10 or greater to about 30, or less.

When the difference of the SP values of the second binder and the non-polar solvent and the difference of the SP values of the first binder and the non-polar solvent are similar each other, dissolving properties of the first binder and the second binder with respect to the non-polar solvent may not substantially change. In the preparation method, the first binder may be added into the non-polar solvent, in which the second binder is already dissolved. By adding the binders in this order, a structure including the non-continuously existing first binder and the continuously existing second binder may be easily formed.

By properly selecting the non-polar solvent, the first binder, and the second binder, an absolute value of difference between the SP values of the non-polar solvent and the first binder and an absolute value of difference between the SP values of the non-polar solvent and the second binder each respectively fall within the ranges above, thus an absolute value of difference between the SP values of the first binder and the second binder may be in a range of about 1 or greater to about 25, or less.

The first binder may be a compound having a structural unit represented by Formula 1 above. An example of the first binder may be PVdF. Also, the first binder may be a compound comprising a structural unit represented by Formula 2 above. An example of the first binder may be PVA. Further, examples of the first binder may include at least one selected from a polyacrylic acid ester copolymer, a vinylidenefluoride-hexafluoropropylene (VDF-HFP) copolymer, polychloroethylene, polymethacrylic acid ester, an ethylene-vinyl alcohol copolymer, polyimide, polyamide, polyamideimde, and a partially or completely hydrogenated product or a carbonic acid-modified product of the polymers. A molecular weight of the compound may be in a range of about 1×10⁵ to about 1×10⁷ Da, or, for example, about 2×10⁵ to about 8×10⁶ Da. The examples of the first binder have stronger adhesive properties than that of elastomers such as styrene butadiene rubber (SBR), butadiene rubber (BR), nitrile butadiene rubber (NBR), a styrene butadiene styrene block copolymer (SBS), a styrene ethylene butadiene styrene block copolymer (SEB), and a styrene-(styrene butadiene)-styrene block copolymer; natural rubber (NR); isoprene rubber (IR); and an ethylene-propylene-diene ternary copolymer (EPDM) that are listed as the examples of the second binder.

An average particle diameter of particles of the first binder may be in a range of about 0.01 micrometers (μm) to about 10 μm, or, for example, about 0.1 μm to about 5 μm. When the first binder with a desired particle diameter is interposed between particles of a positive electrode active material or a solid electrolyte, by pressing the positive electrode layer prepared by using the positive electrode mixture, the first binder may be fused between the particles and spread on the contacting surfaces of the particles to strongly and firmly bind the positive electrode active material or the solid electrolyte. Therefore, although it may not be homogeneously dispersed in the positive electrode mixture, the first binder may significantly contribute to adhesion between the positive electrode layer and other layers. In this regard, interlayer detachment of the stack structure of the all solid secondary battery may be prevented, and thus a lifespan of the all solid secondary battery may be improved.

An amount of each of additives may be appropriately selected in response to a specific surface area of the positive electrode active material or the solid electrolyte that is used. That is, amounts of the additives with respect to the positive electrode active material and the solid electrolyte may be selected based on the specific surface area of the positive electrode active material or the solid electrolyte so as to secure as large as possible contacting area with the positive electrode active material or the solid electrolyte. Further, a sufficient amount of a binder may be added to secure the contacting area.

For example, when a solid electrolyte having an average value of a specific surface area of 2 square meters per gram (m²/g), a positive electrode active material having an average value of a specific surface area of 0.1 m²/g, and the first binder and the second binder of the preparation method are added into the non-polar solvent, the amounts of each of the additives based on 100 parts by weight of the positive electrode mixture may be as follows. An amount of the positive electrode active material may be in a range of about 49.9 parts to about 99 parts by weight, or, for example, about 59.9 parts to about 95 parts by weight. An amount of the solid electrolyte may be in a range of about 1 part to about 50 parts by weight, or, for example, about 5 parts to about 40 parts by weight. An amount of the first binder may be in a range of about 0.05 part to about 8 parts by weight, or, for example, about 0.1 part to about 5 parts by weight. An amount of the second binder may be in a range of about 0.05 part to about 2 parts by weight, or, for example, about 0.1 part to about 1 part by weight.

In another embodiment, when a solid electrolyte having an average value of a specific surface area of 2 m²/g, a positive electrode active material having an average value of a specific surface area of 1.0 m²/g, and the first binder and the second binder of the preparation method are added into the solvent, the amounts of each of the additives based on 100 parts by weight of the positive electrode mixture may be as follows. An amount of the positive electrode active material may be in a range of about 49.9 parts to about 99 parts by weight, or, for example, about 59.9 parts to about 95 parts by weight. An amount of the solid electrolyte may be in a range of about 1 part to about 50 parts by weight, or, for example, about 5 parts to about 40 parts by weight. An amount of the first binder may be in a range of about 0.05 part to about 8 parts by weight, or, for example, about 0.5 part to about 6 parts by weight. An amount of the second binder may be in a range of about 0.05 part to about 2 parts by weight, or, for example, about 0.1 part to about 1 part by weight.

In another embodiment, when a solid electrolyte having an average value of a specific surface area of 2 m²/g, a positive electrode active material having an average value of a specific surface area of 10.0 m²/g, and the first binder and the second binder of the preparation method are added to the solvent, the amounts of each of the additives based on 100 parts by weight of the positive electrode mixture may be as follows. An amount of the positive electrode active material may be in a range of about 49.5 parts to about 99 parts by weight, or, for example, about 59.9 parts to about 95 parts by weight. An amount of the solid electrolyte may be in a range of about 1 part to about 50 parts by weight, or, for example, about 5 parts to about 40 parts by weight. An amount of the first binder may be in a range of about 0.4 part to about 9 parts by weight, or, for example, about 0.5 part to about 8 parts by weight. An amount of the second binder may be in a range of about 0.1 part to about 3 parts by weight, or, for example, about 0.2 part to about 1.5 part by weight.

In another embodiment, when a solid electrolyte having an average value of a specific surface area of 10 m²/g, a positive electrode active material having an average value of a specific surface area of 1.0 m²/g, and the first binder and the second binder of the preparation method are added to the solvent, the amounts of each of the additives based on 100 parts by weight of the positive electrode mixture may be as follows. An amount of the positive electrode active material may be in a range of about 49.5 parts to about 99 parts by weight, or, for example, about 59.9 parts to about 95 parts by weight. An amount of the solid electrolyte may be in a range of about 1 part to about 50 parts by weight, or, for example, about 5 parts to about 40 parts by weight. An amount of the first binder may be in a range of about 0.4 part to about 9 parts by weight, or, for example, about 0.5 part to about 7 parts by weight. An amount of the second binder may be in a range of about 0.1 part to about 3 parts by weight, or, for example, about 0.2 part to about 1.5 part by weight.

A viscosity of the positive electrode mixture may be controlled by controlling an amount of a thickening agent or a non-polar solvent to maintain excellent handling property of the positive electrode mixture. A viscosity of the positive electrode mixture may be in a range of about 5 pascal-seconds (Pa·s) to about 20 Pa·s at room temperature. When a viscosity is too high, the positive electrode mixture may not be evenly coated on a current collector, and when a viscosity is too low, the positive electrode mixture flows, and thus a positive electrode layer may not be formed.

Process of Preparing Negative Electrode Mixture

A negative electrode mixture used in the preparation method may be prepared in the same manner as in the process of preparing a positive electrode mixture, except that a negative electrode active material is used instead of the positive electrode active material among the additives of the positive electrode mixture in the process of preparing positive electrode mixture. In the negative electrode mixture, the non-polar solvent, the negative electrode active material, the solid electrolyte, the first binder, and the second binder described above may be added. A viscosity of the negative electrode mixture may be in a range of about 1 Pa·s to about 15 Pa·s. In this regard, a current collector may be appropriately coated with the negative electrode mixture.

An amount of each of the additives may be appropriately selected in response to a specific surface area of the negative electrode active material or the solid electrolyte. For example, when a solid electrolyte having an average value of a specific surface area of 2 m²/g, a negative electrode active material having an average value of a specific surface area of 1 m²/g, and the first binder and the second binder of the preparation method are added to the non-polar solvent, the amounts of each of the additives based on 100 parts by weight of the negative electrode mixture may be as follows. An amount of the negative electrode active material at an amount in a range of about 49.9 parts to about 99 parts by weight, or, for example, about 59.9 parts to about 95 parts by weight. An amount of the solid electrolyte may be in a range of about 1 part to about 50 parts by weight, or, for example, about 5 parts to about 40 parts by weight. An amount of the first binder may be in a range of about 0.05 part to about 8 parts by weight, or, for example, about 0.1 part to about 7 parts by weight. An amount of the second binder may be in a range of about 0.05 part to about 3 parts by weight, or, for example, about 0.1 part to about 2 parts by weight.

In another embodiment, when a solid electrolyte having an average value of a specific surface area of 2 m²/g, a negative electrode active material having an average value of a specific surface area of 2 m²/g, and the first binder and the second binder of the preparation method are added to the solvent, the amounts of each of the additives based on 100 parts by weight of the negative electrode mixture may be as follows. An amount of the negative electrode active material may be in a range of about 49.9 parts to about 99 parts by weight, or, for example, about 59.5 parts to about 95 parts by weight. An amount of the solid electrolyte may be in a range of about 1 part to about 50 parts by weight, or, for example, about 5 parts to about 40 parts by weight. An amount of the first binder may be in a range of about 0.05 part to about 8 parts by weight, or, for example, about 0.1 part to about 7 parts by weight. An amount of the second binder may be in a range of about 0.05 part to about 3 parts by weight, or, for example, about 0.1 part to about 2 parts by weight.

In another embodiment, when a solid electrolyte having an average value of a specific surface area of 2 m²/g, a negative electrode active material having an average value of a specific surface area of 10 m²/g, and the first binder and the second binder of the preparation method are added to the solvent, the amounts of each of the additives based on 100 parts by weight of the negative electrode mixture may be as follows. An amount of the negative electrode active material may be in a range of about 49.5 parts to about 99 parts by weight, or, for example, about 59.5 parts to about 95 parts by weight. An amount of the solid electrolyte may be in a range of about 1 part to about 50 parts by weight, or, for example, about 5 parts to about 40 parts by weight. An amount of the first binder may be in a range of about 0.4 part to about 9 parts by weight, or, for example, about 0.5 part to about 8 parts by weight. An amount of the second binder may be in a range of about 0.1 part to about 5 parts by weight, or, for example, about 0.2 part to about 3 parts by weight.

In another embodiment, when a solid electrolyte having an average value of a specific surface area of 10 m²/g, a negative electrode active material having an average value of a specific surface area of 10 m²/g, and the first binder and the second binder of the preparation method are added to the solvent, the amounts of each of the additives based on 100 parts by weight of the negative electrode mixture may be as follows. An amount of the negative electrode active material at an amount in a range of about 49.5 parts to about 99 parts by weight, or, for example, about 59.5 parts to about 95 parts by weight. An amount of the solid electrolyte may be in a range of about 1 part to about 50 parts by weight, or, for example, about 5 parts to about 40 parts by weight. An amount of the first binder may be in a range of about 0.4 part to about 10 parts by weight, or, for example, about 0.5 part to about 9 parts by weight. An amount of the second binder may be in a range of about 0.1 part to about 4 parts by weight, or, for example, about 0.2 part to about 4 parts by weight.

### Process of Preparing Positive Electrode Layer and Negative Electrode Layer

A positive electrode layer and a negative electrode layer may be each prepared by coating a current collector with the positive electrode mixture or the negative electrode mixture, respectively, with a thickness in a range of about 250 μm to about 300 μm, or, for example, about 150 μm to about 200 μm, and drying the mixture to remove a non-polar solvent therefrom. A material for the current collector may be at least one selected from copper, nickel, titanium, and aluminum and may be in a sheet-shape or a film-shape. The positive electrode layer or the negative electrode layer including the first binder and the second binder as prepared by using the preparation method may contribute in prevention of detachment between the positive electrode layer or the negative electrode layer and the solid electrode layer since the positive electrode layer or the negative electrode layer includes a binder with high adhesive strength in a certain amount.

The coating of the current collector with the positive electrode mixture or the negative electrode mixture may be performed by using a dye coater or a doctor blade coating method. When the first binder has a structural unit represented by Formula 1, a heat-treatment temperature may be in a range of about 60° C. to about 150° C., and a heat-treatment time may be in a range of about 15 minutes to about 30 minutes. When the first binder has a structural unit represented by Formula 2, a heat-treatment temperature may be in a range of about 40° C. to about 120° C., and a heat-treatment time may be in a range of about 10 minutes to about 30 minutes. After the heat-treatment, the positive electrode mixture or the negative electrode mixture may be vacuum dried to remove the non-polar solvent, thereby preparing the positive electrode layer or the negative electrode layer that is used in the preparation method. The vacuum drying may be performed at a temperature in a range of about 40° C. to about 120° C., or, for example, about 60° C. to about 100° C. A thickness of the positive electrode layer after the vacuum drying may be in a range of about 150 μm to about 200 μm. A thickness of the negative electrode layer after the vacuum drying may be in a range of about 100 μm to about 180 μm.

### Process of Forming Solid Electrolyte Layer

A solid electrolyte layer of the preparation method may be prepared by mixing a solid electrolyte, a first binder, and a second binder. Mixing of a sulfide solid electrolyte, the first binder, and the second binder may be performed by preparing a solid electrolyte composition, or by filling a solid electrolyte powder and a powder of each of the binders between a positive electrode layer and a negative electrode layer in a cell case of the all solid secondary battery. In order to homogeneously mix the solid electrolyte, the first binder, and the second binder, the mixing may be performed by preparing the solid electrolyte composition.

When the mixing is performed by preparing the solid electrolyte composition in the preparation method, mixing of the solid electrolyte with the first binder and the second binder may be performed by stirring in a solvent. As the solid electrolyte, the solid electrolyte described above may be used, and an example of the solid electrolyte may include a sulfide solid electrolyte. The sulfide solid electrolyte may be synthesized by mixing at least one compound selected from the group consisting of silicon sulfide, phosphorus sulfide, and boron sulfide and lithium sulfide as starting material, where a molar ratio of the total amount of the compound and an amount of the lithium sulfide may be in a range of about 50:50 to about 30:70. A method of the mixing may be a MM method or a solution method.

A viscosity of the solid electrolyte composition may be in a range of about 1 Pa·s to about 15 Pa·s, or, for example, about 2 Pa·s to about 12 Pa·s. The viscosity may be controlled by increasing an amount of the solvent or by adding a thickening agent. The solvent may be a non-polar solvent such as xylene or toluene. When the solvent or the thickening agent may be added so that a viscosity of the solid electrolyte composition may be within the range above, the second binder of the preparation method is dissolved, and thus the second binder may be homogenously dissolved in the solid electrolyte composition. The first binder is not dissolved but may be dispersed in the form of particles within the solid electrolyte composition.

An amount of each of additives may be appropriately controlled in response to a specific surface area of the solid electrolyte. For example, when a solid electrolyte having an average value of a specific surface area of 2 m²/g, and the first binder and the second binder of the preparation method are added to the non-polar solvent, the amounts of each of the additives based on 100 parts by weight of the solid electrolyte composition, which may be obtained by adding the additives to the solvent, may be as follows. An amount of the solid electrolyte may be in a range of about 90 parts to about 90.9 parts by weight, or, for example, about 95 parts to about 99.8 parts by weight. An amount of the first binder may be in a range of about 0.05 part to about 8 parts by weight, or, for example, about 0.1 part to about 6 parts by weight. An amount of the second binder may be in a range of about 0.05 part to about 4 parts by weight, or, for example, about 0.1 part to about 3 parts by weight.

In another embodiment, when a solid electrolyte having an average value of a specific surface area of 10 m²/g and the first binder and the second binder of the preparation method are added to the solvent, the amounts of each of the additives based on 100 parts by weight of the solid electrolyte composition may be as follows. An amount of the solid electrolyte may be in a range of about 90 parts to about 99.5 parts by weight, or, for example, about 92 parts to about 99.0 parts by weight. An amount of the first binder may be in a range of about 0.4 part to about 9 parts by weight, or, for example, about 1.0 part to about 8 parts by weight. An amount of the second binder may be in a range of about 0.1 part to about 6 parts by weight, or, for example, about 0.5 part to about 5 parts by weight.

A support that has a flat surface and is formed of polyethylene terephthalate (PET) may be coated with the prepared solid electrolyte mixture as a coating layer by using a dye coater. A thickness of the coating layer may be in a range of about 150 μm to about 200 μm. A solvent in the solid electrolyte composition coating the support may be removed by heat-treatment. When the solvent is a non-polar solvent, a reaction between the solid electrolyte and the solvent may be prevented, and thus deterioration of lithium ion conductivity of the sulfide solid electrolyte, which occur before complete removal of the solvent, may be suppressed. A heat-treatment temperature may be in a range of about 60° C. to about 150° C., and a heat-treatment time may be in a range of about 15 minutes to about 30 minutes. After the heat-treatment, the solid electrolyte composition may be vacuum-dried, thereby preparing the solid electrolyte layer that may be used in the preparation method. The vacuum drying may be performed at a temperature in a range of about 40° C. to about 120° C., or, for example, about 60° C. to about 100° C. The solid electrolyte layer may be prepared by peeling off the dried solid electrolyte layer from the support.

A method of mixing the solid electrolyte with the first binder and the second binder without using a solvent may be a mixing method including stirring a solid electrolyte and a powder of each of the binders using a ball mill and press-molding the resultant. In this method, a pressure condition for the molding may be in a range of about 0.1 ton/cm² to about 5 ton/cm², or, for example, about 1 ton/cm² to about 4 ton/cm².

The positive electrode layer, the solid electrolyte layer, and the negative electrode layer each prepared are stacked in an inert atmosphere and integrated by applying a pressure on the stack to prepare the all solid secondary battery. A pressure condition may be in a range of about 0.5 ton/cm² to about 10 ton/cm², or, for example, about 2 ton/cm² to about 6 ton/cm². The first binder is non-continuously present and the second binder is continuously present within a layer including the first binder and the second binder. When the stack is pressed, the first binder that is included in at least one of the layers may be fused within the layer. In this regard, the first binder may exhibit a strong and firm adhesive strength in an interposed region between particles of the solid electrolyte, the positive electrode active material, and the negative electrode active material. Accordingly, the all solid secondary battery may have good adhesiveness in an interface between the layers. The all solid secondary battery may have less occurrence of interlayer detachment over repeated charging and discharging, and may have a long lifespan.

### EXAMPLES

### Example 1

As Example 1, an all solid secondary battery having a positive electrode layer including a first binder and a second binder was prepared. The positive electrode layer is prepared in the following manner. A LiNiCoAlO₂ ternary powder, as a positive electrode active material, a Li₂S—P₂S₅ (at a mol % ratio of 80:20) amorphous powder, as a sulfide-based solid electrolyte, a vapor growth carbon fiber powder, as a conducting agent, were weighed at a weight % ratio of about 60:35:5 and mixed by using a rotation and revolution mixer.

SBR was dissolved in a dehydrated xylene solution to prepare a second binder, and the second binder was added to the mixed powder to prepare a primary mixture solution. In the primary mixture solution, an amount of SBR was about 1.0 weight %, based on the total weight of the mixed powder. PVdF having an average particle diameter of about 3 μm, as a first binder, was added to the primary mixture solution, and an appropriate amount of dehydrated xylene was additionally added thereto to control a viscosity, and thus a secondary mixture solution was prepared. An amount of PVdF was about 5.0 weight % based on the total weight of the mixed powder.

Additionally, a zirconium oxide ball having a diameter of about 5 mm was added to the secondary mixture solution so that an empty space, the mixture powder, and the zirconium oxide ball may each occupy ⅓ of the total volume in a milling container, and the content in the container was milled to improve dispersibility of the mixed powder to prepare a tertiary mixture solution. The tertiary mixture solution was added to a rotation and revolution mixer and stirred at a rate of 3000 rpm for 3 minutes to prepare a positive electrode mixture.

An aluminum film current collector having a thickness of 15 μm was prepared as a positive electrode current collector, and the positive electrode current collector was placed in a desktop screen printer. The positive electrode current collector was coated with a positive electrode mixture by using a metal mask having a thickness of 150 μm. The positive electrode current collector coated with the positive electrode mixture was dried on a hot plate at a temperature of about 120° C. for 30 minutes, and then vacuum dried at a temperature of 80° C. for 12 hours to form a positive electrode layer on the positive electrode current collector. After the drying, the total thickness of the positive electrode current collector and the positive electrode layer was about 165 μm.

A sheet formed of the positive electrode current collector and the positive electrode layer was pressed by using a roll-press having a roll gap of about 20 μm to prepare a positive electrode structure formed of the positive electrode current collector and the positive electrode layer. A thickness of the positive electrode structure after drying was about 120 μm.

In an inert gas atmosphere, the positive electrode structure was used in a molding jig having a cylinder shape with an internal diameter of 1.3 cm to prepare an all solid secondary battery. 100 milligrams (mg) of a Li₂S—P₂S₅ (at a mol % ratio of 80:20) amorphous powder was inserted into the molding jig, press-molded at a pressure of about 2 ton/cm² to prepare a solid electrolyte layer. The positive electrode structure was cut into a circle having a diameter of 1.3 cm, placed on the solid electrolyte layer in the molding jig, press-molded at a pressure of about 2 ton/cm² to integrate the solid electrolyte layer and the positive electrode mixture layer.

Next, 20.0 mg of graphite powder that was vacuum dried at a temperature of 80° C. for 24 hours and a negative electrode current collector were inserted on a surface of the solid electrolyte layer which is opposite to a surface on which the positive electrode layer is formed. After the insertion, the resultant was press-molded at a pressure of 4 ton/cm² to integrate the solid electrolyte layer, the negative electrode layer, and the negative electrode current collector. In this regard, a cell of an all solid secondary battery, in which a solid electrolyte layer was interposed between the positive electrode layer and the negative electrode layer, was prepared.

### Examples 2 to 5

Examples 2 to 5 were performed in the same manner as in Example 1, except that a second binder and a solvent of Table 1 were used instead of the second binder and the solvent used in Example 1.

### Example 6

In Example 6, an all solid secondary battery having a negative electrode layer including PVdF as a binder was prepared. First, in order to prepare a negative electrode mixture, a graphite powder that was vacuum dried at a temperature of 80° C. for 24 hours, as a negative electrode active material, a Li₂S—P₂S₅ (at a mol % ratio of 80:20) amorphous powder, as a sulfide-based solid electrolyte, and a vapor growth carbon fiber powder, as a negative electrode layer conducting agent, were weighed at a weight % ratio of about 60:35:5 and mixed by using a rotation and revolution mixer.

SBR was dissolved in a dehydrated xylene solution to prepare a second binder, and the second binder was added to the mixed powder to prepare a primary mixture solution. In the primary mixture solution, an amount of SBR was about 3.0 weight % based on the total weight of the mixed powder. PVdF having an average particle diameter of about 3 μm, as a first binder, was added to the primary mixture solution, and an appropriate amount of dehydrated xylene was additionally added thereto to control a viscosity, and thus a secondary mixture solution was prepared. An amount of PVdF was about 2.0 weight % based on the total weight of the mixed powder.

Additionally, a zirconium oxide ball having a diameter of about 5 mm was added to the secondary mixture solution so that an empty space, the mixture powder, and the zirconium oxide ball may each occupy ⅓ of the total volume in a milling container, and the content in the container was milled to improve dispersibility of the mixture powder to prepare a tertiary mixture solution. The tertiary mixture solution was added to a rotation and revolution mixer and stirred at a rate of 3000 rpm for 3 minutes to prepare a negative electrode mixture.

A copper film current collector having a thickness of 15 μm was prepared as a negative electrode current collector, and the negative electrode current collector was placed in a desktop screen printer. The negative electrode current collector was coated with a negative electrode mixture by using a metal mask having a thickness of 150 μm. The negative electrode current collector coated with the negative electrode mixture was dried on a hot plate at a temperature of about 120° C. for 30 minutes, and then vacuum dried at a temperature of 80° C. for 12 hours to form a negative electrode layer on the negative electrode current collector. After the drying, the total thickness of the negative electrode current collector and the negative electrode layer was about 165 μm.

A sheet formed of the negative electrode current collector and the negative electrode layer was pressed by using a roll-press having a roll gap of about 20 μm to prepare a negative electrode structure formed of the negative electrode current collector and the negative electrode layer. A thickness of the negative electrode structure after drying was about 120 μm.

A positive electrode mixture was prepared in the following manner. A LiNiCoAlO₂ ternary powder, as a positive electrode active material, a Li₂S—P₂S₅ (at a mol % ratio of 80:20) amorphous powder, as a sulfide-based solid electrolyte, a vapor growth carbon fiber powder, as a positive electrode layer conducting agent, were weighed at a weight % ratio of about 60:35:5, added with an additional second binder, and mixed by using a rotation and revolution mixer.

A dehydrated xylene solution was added to the mixed powder to prepare a primary mixture solution. An appropriate amount of dehydrated xylene was additionally added to the primary mixture solution, a viscosity of the mixture was controlled, and thus a secondary mixture solution was prepared. Additionally, a zirconium oxide ball having a diameter of about 5 mm was added to the secondary mixture solution so that an empty space, the mixture powder, and the zirconium oxide ball may each occupy ⅓ of the total volume in a milling container, and the content in the container was milled to improve dispersibility of the mixed powder to prepare a tertiary mixture solution. The tertiary mixture solution was added to a rotation and revolution mixer and stirred at a rate of 3000 rpm for 3 minutes to prepare a positive electrode mixture.

An aluminum film current collector having a thickness of 15 μm was prepared as a positive electrode current collector, and the positive electrode current collector was placed in a desktop screen printer. The positive electrode current collector was coated with a positive electrode mixture by using a metal mask having a thickness of 150 μm. The positive electrode current collector coated with the positive electrode mixture was dried on a hot plate at a temperature of about 120° C. for 30 minutes, and then vacuum dried at a temperature of 80° C. for 12 hours to form a positive electrode layer on the positive electrode current collector. After the drying, the total thickness of the positive electrode current collector and the positive electrode layer was about 165 μm.

A sheet formed of the positive electrode current collector and the positive electrode layer was pressed by using a roll-press having a roll gap of about 10 μm to prepare a positive electrode structure formed of the positive electrode current collector and the positive electrode layer. A thickness of the positive electrode structure after drying was about 120 μm.

In an inert gas atmosphere, the positive electrode structure was used in a molding jig having a cylinder shape with an internal diameter of 1.3 cm to prepare an all solid secondary battery. 100 mg of a Li₂S—P₂S₅ (at a mol % ratio of 80:20) amorphous powder was inserted to the molding jig, press-molded at a pressure of about 2 ton/cm² to prepare a solid electrolyte layer. The positive electrode structure and the negative electrode structure were each respectively cut into a circle having a diameter of 1.3 cm, then each of them were placed on both surfaces of the solid electrolyte layer in the molding jig, press-molded at a pressure of about 2 ton/cm² to integrate the negative electrode layer, the solid electrolyte layer, and the positive electrode layer. In this regard, a cell of an all solid secondary battery having a solid electrolyte layer that is interposed between the positive electrode layer and the negative electrode layer was obtained. The obtained solid electrolyte secondary battery was prepared in Example 6.

### Example 7

In Example 7, an all solid secondary battery having a solid electrolyte layer including PVdF as a binder was prepared. First, in order to prepare a solid electrolyte composition, a Li₂S—P₂S₅ (at a mol % ratio of 80:20) amorphous powder, as a sulfide-based solid electrolyte, was added to a dehydrated xylene solution including SBR dissolved therein, as a second binder, to prepare a primary mixture solution. PVdF, as a first binder, was added to the primary mixture solution, and a dehydrated xylene solution was additionally added thereto to control a viscosity of the mixture to prepare a secondary mixture solution. An amount of SBR was 2 weight % based on the total weight of the solid electrolyte power. An amount of PVdF was 5 weight % based on the total weight of the solid electrolyte powder.

Additionally, a zirconium oxide ball having a diameter of about 5 mm was added to the secondary mixture solution so that an empty space, the solid electrolyte, and the zirconium oxide ball may each occupy ⅓ of the total volume in a milling container, and the content in the container was milled to improve dispersibility of the solid electrolyte to prepare a tertiary mixture solution. The tertiary mixture solution was added to a rotation and revolution mixer and stirred at a rate of 3000 rpm for 3 minutes to prepare a solid electrolyte composition.

A PET sheet having a thickness of 15 μm was prepared as a support, and the support was placed in a desktop screen printer. The support was coated with the solid electrolyte composition by using a metal mask having a thickness of 150 μm. The support coated with the solid electrolyte composition was dried on a hot plate at a temperature of about 120° C. for 30 minutes, and then vacuum dried at a temperature of 80° C. for 12 hours to form a solid electrolyte layer on the support.

A sheet formed of the support and the solid electrolyte layer was pressed by using a roll-press having a roll gap of about 10 μm, and then the solid electrolyte layer was peeled off from the support. A thickness of the solid electrolyte layer after drying was about 120 μm.

A negative electrode mixture was prepared in the following manner. A graphite powder vacuum dried at a temperature of 80° C. for 24 hours, as a negative electrode active material and a vapor growth carbon fiber powder, as a negative electrode layer conducting agent were weighed at a weight % ratio of about 90:10 and mixed by using a rotation and revolution mixer.

A dehydrated N-methylpyrrolidone (NMP) solution was added to the mixed powder to prepare a primary mixture solution. An appropriate amount of the dehydrated NMP was added to the primary mixture solution thus obtained to control a viscosity to prepare a secondary mixture solution. Additionally, a zirconium oxide ball having a diameter of about 5 mm was added to the secondary mixture solution so that an empty space, the mixed powder, and the zirconium oxide ball may each occupy ⅓ of the total volume in a milling container, and the content in the container was milled to improve dispersibility of the mixed powder to prepare a tertiary mixture solution. The tertiary mixture solution was added to a rotation and revolution mixer and stirred at a rate of 3000 rpm for 3 minutes to prepare a negative electrode mixture.

A copper film current collector having a thickness of 15 μm was prepared as a negative electrode current collector, and the negative electrode current collector was placed in a desktop screen printer. The negative electrode current collector was coated with the negative electrode mixture by using a metal mask having a thickness of 150 μm. The negative electrode current collector coated with the negative electrode mixture was dried on a hot plate at a temperature of about 120° C. for 30 minutes, and then vacuum dried at a temperature of 80° C. for 12 hours to form a negative electrode layer on the negative electrode current collector. After the drying, the total thickness of the negative electrode current collector and the negative electrode layer was about 165 μm.

A sheet formed of the negative electrode current collector and the negative electrode layer was pressed by using a roll-press having a roll gap of about 20 μm to prepare a negative electrode structure formed of the negative electrode current collector and the negative electrode layer. A thickness of the negative electrode structure after drying was about 120 μm.

In an inert gas atmosphere, the negative electrode structure and the solid electrolyte layer were used in a molding jig having a cylinder shape with an internal diameter of 1.3 cm to prepare an all solid secondary battery. In the molding jig, the negative electrode structure and the solid electrolyte layer were placed, and press-molded at a pressure of about 2 ton/cm² to integrate the negative electrode structure and the solid electrolyte layer, and thus to form the negative electrode layer and the solid electrolyte layer. Subsequently, a LiNiCoAlO₂ ternary powder, as a positive electrode active material, a Li₂S—P₂S₅ (at a mol % ratio of 80:20) amorphous powder, as a sulfide-based solid electrolyte, and a vapor growth carbon fiber powder, as a positive electrode layer conducting agent, were weighted at a weight % ratio of 60:35:5, and 20 mg of the mixed powder and a positive electrode current collector were inserted on a surface of the solid electrolyte layer which is opposite to a surface, on which the negative electrode layer of the solid electrolyte layer were formed. After the insertion, the resultant was press-molded at a pressure of about 4 ton/cm² to integrate the positive electrode current collector, positive electrode layer, solid electrolyte layer, negative electrode layer, and negative electrode current collector. In this regard, a cell of an all solid secondary battery having the solid electrolyte layer that is interposed between the positive electrode layer and the negative electrode layer was prepared. The solid electrolyte secondary battery thus obtained was prepared in Example 7.

### Example 8

In Example 8, a LiNiCoAlO₂ ternary powder, as a positive electrode active material, a Li₂S—P₂S₅ (at a mol % ratio of 80:20) amorphous powder, as a sulfide-based solid electrolyte, a vapor growth carbon fiber powder, as a positive electrode layer conducting agent, were weighed at a weight % ratio of about 60:35:5 and mixed by using a rotation and revolution mixer.

A dehydrated xylene solution including SBR dissolved therein, as a second binder, was added to the mixed powder to prepare a primary mixture solution. An amount of the primary mixture solution was about 1.0 weight % based on the total weight of the mixed powder. PVA having an average particle diameter of 4 μm, as a first binder, was added to the primary mixture solution thus obtained, and an appropriate amount of an additional dehydrated xylene was added to thereto to control a viscosity to prepare a secondary mixture solution. An amount of PVA was 7.0 weight % based on the total weight of the mixed powder.

Additionally, a zirconium oxide ball having a diameter of about 5 mm was added to the secondary mixture solution so that an empty space, the mixed powder, and the zirconium oxide ball may each occupy ⅓ of the total volume in a milling container, and the content in the container was milled to improve dispersibility of the mixed powder to prepare a tertiary mixture solution. The tertiary mixture solution was added to a rotation and revolution mixer and stirred at a rate of 3000 rpm for 3 minutes to prepare a positive electrode mixture.

An aluminum film current collector having a thickness of 15 μm was prepared as a positive electrode current collector, and the positive electrode current collector was placed in a desktop screen printer. The positive electrode current collector was coated with a positive electrode mixture by using a metal mask having a thickness of 150 μm. The positive electrode current collector coated with the positive electrode mixture was dried on a hot plate at a temperature of about 120° C. for 30 minutes, and then vacuum dried at a temperature of 80° C. for 12 hours to form a positive electrode layer on the positive electrode current collector. After the drying, the total thickness of the positive electrode current collector and the positive electrode layer was about 150 μm.

A sheet formed of the positive electrode current collector and the positive electrode layer was pressed by using a roll-press having a roll gap of about 20 μm to prepare a positive electrode structure formed of the positive electrode current collector and the positive electrode layer. A thickness of the positive electrode structure after drying was about 110 μm.

In an inert gas atmosphere, the positive electrode structure was used in a molding jig having a cylinder shape with an internal diameter of 1.3 cm to prepare an all solid secondary battery. 100 mg of a Li₂S—P₂S₅ (at a mol % ratio of 80:20) amorphous powder was inserted to the molding jig, then press-molded at a pressure of about 2 ton/cm² to prepare a solid electrolyte layer. The positive electrode structure was cut into a circle having a diameter of 1.3 cm, placed on the solid electrolyte layer in the molding jig, and press-molded at a pressure of about 2 ton/cm² to integrate the solid electrolyte layer and the positive electrode mixture layer.

Next, 20.0 mg of graphite powder that was vacuum dried at a temperature of 80° C. for 24 hours and a negative electrode current collector were inserted on a surface of the solid electrolyte layer which is opposite to a surface on which the positive electrode layer and the solid electrolyte layer were formed. After the insertion, the resultant was press-molded at a pressure of 4 ton/cm² to integrate the solid electrolyte layer, the negative electrode layer, and the negative electrode current collector. In this regard, a cell of an all solid secondary battery, in which a solid electrolyte layer was interposed between the positive electrode layer and the negative electrode layer, was prepared.

### Examples 9 and 10

A cell of Example 9 was prepared in the same manner as in Example 8, except that the second binder used in Example 8 was SBS instead of SBR. Also, a cell of Example 10 was obtained in the same manner as in Example 8, except that the second binder used in Example 8 was NBR instead of SBR.

### Comparative Examples 1 to 5

An all solid secondary battery of Comparative Example 1 was prepared by manufacturing a positive electrode layer in the same manner as in Example 1, except that the first binder was not added, and the second binder and the solvent of the positive electrode mixture were changed to Table 1. Further, an all solid secondary battery of Comparative Example 2 was prepared by manufacturing a negative electrode layer in the same manner as in Example 1, except that the first binder was not added, and the second binder and the solvent of the negative electrode mixture were changed to Table 1.

Preparation of an all solid secondary battery of Comparative Example 3 was performed in the same manner as in Example 1, except that the second binder was not added, and the first binder and solvent of the positive electrode mixture were changed to Table 1. Preparation of an all solid secondary battery of Comparative Example 4 was performed in the same manner as in Example 1, except that the first binder was not added, and the second binder and solvent of the positive electrode mixture were changed to Table 1. However, in regard of Comparative Example 3 and Comparative Example 4, a positive electrode layer was not formed since a viscosity of the positive electrode mixture was insufficient. Further, preparation of an all solid secondary battery of Comparative Example 5 was performed in the same manner as in Example 1, except that the second binder was not added, and the first binder and the solvent of the positive electrode mixture were changed to Table 1. In regard of Comparative Example 5, a positive electrode layer was not formed since the sulfide solid electrolyte and PVdF reacted and formed a gel.

Cycle Test

A charging/discharging cycle at a constant current of 0.05 C was performed on the all solid secondary batteries prepared in Examples 1 to 10 and Comparative Examples 1 and 2 at room temperature to measure discharge capacities of each of the batteries at first cycle and 50^{th} cycle.

The charging/discharging cycle at a constant current of 0.05 C was performed at room temperature. After 50^{th} cycle, a single cell was disassembled to check adhesion between a positive electrode layer and a current collector. Regarding the batteries prepared in Examples 1 to 10, detachment of the positive electrode layer from the current collector was not observed. Further, adhesion of particles included in the positive electrode layer, negative electrode layer, and solid electrolyte layer was maintained. However, it was confirmed that an electrode and a current collector film was separated in the batteries prepared in Comparative Examples 1 and 2.

Also, when a discharge capacity after the 50^{th} cycle is compared with a discharge capacity after a first cycle, as 100%, a discharge capacity retention ratio after 50^{th} cycle may be obtained. The results are shown in Table 1.

TABLE 1

| | | | | | | | | Capacity |
|---|---|---|---|---|---|---|---|---|
| | First binder | | Second binder | | | | Layer | retention |
| | | SP | | SP | Difference | | including | ratio at 50^{th} |
| | | value | Name | value | in SP values | Solvent | binders | cycle [%] |
| Example 1 | PVdF | 23.2 | SBR | 16.6 | 6.6 | Xylene | Positive | 86 |
| | | | | | | | electrode | |
| Example 2 | PVdF | 23.2 | SBS | 19.8 | 3.4 | Xylene | Positive | 82 |
| | | | | | | | electrode | |
| Example 3 | PVdF | 23.2 | BR | 17.0 | 6.2 | Xylene | Positive | 79 |
| | | | | | | | electrode | |
| Example 4 | PVdF | 23.2 | NBR | 19.2 | 3.9 | Xylene | Positive | 81 |
| | | | | | | | electrode | |
| Example 5 | PVdF | 23.2 | SBR | 16.6 | 6.6 | Toluene | Positive | 84 |
| | | | | | | | electrode | |
| Example 6 | PVdF | 23.2 | SBR | 16.6 | 6.6 | Xylene | Negative | 83 |
| | | | | | | | electrode | |
| Example 7 | PVdF | 23.2 | SBR | 16.6 | 6.6 | Xylene | Solid | 82 |
| | | | | | | | electrolyte | |
| Example 8 | PVA | 21.7 | SBR | 16.6 | 5.1 | Xylene | Positive | 84 |
| | | | | | | | electrode | |
| Example 9 | PVA | 21.7 | SBS | 19.8 | 1.9 | Xylene | Positive | 78 |
| | | | | | | | electrode | |
| Example 10 | PVA | 21.7 | NBR | 19.2 | 2.5 | Xylene | Positive | 80 |
| | | | | | | | electrode | |
| Comparative | — | — | SBR | 16.6 | — | Xylene | Positive | 48 |
| Example 1 | | | | | | | electrode | |
| Comparative | — | — | SBR | 16.6 | — | Xylene | Negative | 55 |
| Example 2 | | | | | | | electrode | |
| Comparative | PVdF | 23.2 | — | — | — | Xylene | Positive | — |
| Example 3 | | | | | | | electrode | |
| Comparative | — | — | SBR | 16.6 | — | NMP | Positive | — |
| Example 4 | | | | | | | electrode | |
| Comparative | PVdF | 23.2 | — | — | — | NMP | Positive | — |
| Example 5 | | | | | | | electrode | |

As described above, according to the one or more of the above exemplary embodiments, particles included in a battery may not be easily separated when a binder having a strong adhesive strength is used to strongly adhere a positive electrode layer, a solid electrolyte layer, and a negative electrode layer. In this regard, when interlayer detachment is suppressed, an all solid secondary battery may have an improved lifespan. In particular, this may be applied to a battery comprising a sulfide solid electrolyte, and, when the solid electrolyte is included in a battery, the battery may have improved adhesive property and high ion conductivity.

It should be understood that the exemplary embodiments described therein should be considered in a descriptive sense only and not for purposes of limitation. Descriptions of features, advantages, or aspects within each embodiment shall be considered as available for other similar features, advantages, or aspects in other embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An all solid secondary battery comprising:
a positive electrode layer;
a negative electrode layer; and
a solid electrolyte layer that is disposed between the positive electrode layer and the negative electrode layer,
a first binder that is insoluble in a non-polar solvent and is non-continuously present in at least one of the positive electrode layer, the negative electrode layer, and the solid electrolyte layer, and
a second binder that is soluble in non-polar solvent and is continuously present in at least one of the positive electrode layer, the negative electrode layer, and the solid electrolyte layer, and
wherein a solubility parameter of the first binder and a solubility parameter of the second binder are different than each other.

2. The all solid secondary battery of claim 1, wherein the solid electrolyte is inert with respect to the non-polar solvent.

3. The all solid secondary battery of claim 1, wherein the solid electrolyte is a sulfide solid electrolyte.

4. The all solid secondary battery of claim 2, wherein the solid electrolyte comprises Li₂S—P₂S₅.

5. The all solid secondary battery of claim 1, wherein the solubility parameter of the first binder is in a range of about 20 MPa^{1/2} to about 30 MPa^{1/2}.

6. The all solid secondary battery of claim 1, wherein an absolute value of a difference between the solubility parameter of the first binder and a solubility parameter of the non-polar solvent is about 5 or greater.

7. The all solid secondary battery of claim 1, wherein the solubility parameter of the second binder is in a range of about 5 MPa^{1/2} to about 20 MPa^{1/2}.

8. The all solid secondary battery of claim 1, wherein an absolute value of a difference between the solubility parameter of the second binder and a solubility parameter of the non-polar solvent is less than about 15.

9. The all solid secondary battery of claim 1, wherein a particle diameter of the first binder is in a range of about 0.01 micrometer to about 10 micrometers.

10. The all solid secondary battery of claim 1, wherein the first binder comprises a structural unit represented by Formula 1:
—(CH₂—CF₂)—. Formula 1

11. The all solid secondary battery of claim 1, wherein an absolute value of a difference between the solubility parameter of the first binder and the solubility parameter of the second binder is about 3 or greater.

12. The all solid secondary battery of claim 1, wherein the first binder is compound comprising a structural unit represented by Formula 2:
—(CH₂—CH(OH))—. Formula 2

13. The all solid secondary battery of claim 12, wherein an absolute value of a difference between the solubility parameter of the first binder and the solubility parameter of the second binder is about 1 or greater.

14. The all solid secondary battery of claim 1, wherein the first binder comprises at least one selected from polyvinylidene fluoride, polyvinyl alcohol, a polyacrylic acid ester copolymer, a vinylidenefluoride-hexafluoropropylene copolymer, polychloroethylene, polymethacrylic acid ester, an ethylene-vinylalcohol copolymer, polyimide, polyamide, polyamideimde, and a hydrogenated or a carbonic acid-modified derivative thereof.

15. The all solid secondary battery of claim 1, wherein the second binder is a hydrocarbon polymer.

16. The all solid secondary battery of claim 1, wherein the second binder comprises at least one selected from styrene butadiene rubber, butadiene rubber, nitrile butadiene rubber, a styrene butadiene styrene block copolymer, a styrene ethylene butadiene block copolymer, a styrene-(styrene butadiene)-styrene block copolymer, natural rubber, isoprene rubber, and an ethylene-propylene-diene ternary copolymer.

17. The all solid secondary battery of claim 1, wherein the first binder and the second binder comprise a sea-island structure, in which the second binder is a sea component and the first binder is an island component.

18. The all solid secondary battery of claim 17, wherein at least one of an active material particle or a solid electrolyte particle is disposed in the sea-island structure.

19. The all solid secondary battery of claim 1, wherein the non-polar solvent is at least one selected from toluene, xylene, benzene, pentane, hexane, and heptane.

20. A method of preparing an all solid secondary battery, the method comprising at least one of:
adding a positive electrode active material, a solid electrolyte, a first binder that is insoluble in a non-polar solvent, and a second binder that is soluble in the non-polar solvent into the non-polar solvent to prepare a positive electrode mixture;
adding a negative electrode active material, a solid electrolyte, a first binder that is insoluble in the non-polar solvent, and a second binder that is soluble in the non-polar solvent into the non-polar solvent to prepare a negative electrode mixture;
mixing a solid electrolyte, a first binder that is insoluble in the non-polar solvent, and a second binder that is soluble in the non-polar solvent to prepare a solid electrolyte layer; and
disposing the solid electrolyte layer between a positive electrode layer and a negative electrode layer to prepare an all solid secondary battery.
